(19) United States
(12) Patent Application Publication
(10) Pub. No.: US 2011/0181395 A1
(43) Pub. Date: Jul. 28, 2011

(54) Audio Broadcasting Device and Portable Device Using the Same

(76) Inventors: Chuan-Yen Kao, Taipei Hsien (TW); Tzu-Peng Chang, Taipei Hsien (TW)

(21) Appl. No.: 12/978,609

(22) Filed: Dec. 26, 2010

(30) Foreign Application Priority Data
Jan. 22, 2010 (TW) 099101713

(51) Int. Cl. G06K 7/01

(52) U.S. Cl. 340/10.1

(57) ABSTRACT

An audio broadcasting device with a radio frequency identification function is disclosed. The audio broadcasting device includes a loudspeaker comprising a metal coil for generating sounds, an audio processing circuit for outputting an audio signal to the loudspeaker to drive the loudspeaker to generate the sounds, and an electronic tag module comprising a capacitor coupled to the metal coil in parallel, and a storage unit coupled to the capacitor in parallel for storing identification information, wherein the metal coil and the capacitor are utilized for generating an induced voltage potential according to a query signal broadcasted by a wireless radio frequency identification reader, to drive the storage unit to feed the identification information back to the wireless radio frequency identification reader.

### BACKGROUND OF THE INVENTION

1. Field of the Invention

The invention is related to an audio broadcasting device and portable device, and more particularly, to an audio broadcasting device and portable device that transmit and receive radio frequency signals via a metal coil embedded in a loudspeaker.

2. Description of the Prior Art

With advances in information technology, various digital identification cards, such as credit cards, phone cards, automated teller machine (ATM) cards, access cards, etc. are widely used in modern society. Other than traditional contact identification cards, more and more identification systems employ radio frequency (RF) identification techniques, i.e. wirelessly transmitting and receiving RF identification data. As a result, the identification cards can be read and written to without physical contact with a card reader to prevent data loss due to card abrasion.

More specifically, a conventional wireless RF identification system normally includes an electronic tag, a reader and a related application system. The electronic tag (identification card) functions as a transponder, and therefore includes analog, digital and memory chips and an antenna designed based on desired frequency bands and practical application conditions. The reader correspondingly includes analog control, digital control, and microprocessing units and a read antenna. The application system is a middleware program for acquiring or receiving digital identification information stored in the electronic tag via the reader to perform further operations. Once the electronic tag is positioned to be close enough to the reader, the antennas are magnetically and mutually coupled by resonance, resulting in an induced voltage potential in the electronic tag, which supplies the required operating power of the electronic tag, such that the reader and the electronic tag can wirelessly communicate with each other.

That is, when an identification requirement arises, a user merely has to position the identification card (the electronic tag) close to the reader. Using such a simple architecture, the identification cards can be implemented with small physical volume, which makes it easy for the user to lose and damage the identification card, resulting in inconvenience and even financial loss to the user. In such a situation, an increasing number of portable electronic devices, such as mobile phones, personal digital assistants (PDAs), etc., further utilize a wireless RF identification function to implement applications like a digital wallet, personal identification, etc. However, these designs simply combine the portable electronic devices with the identification cards to simultaneously include ordinary portable device functions and wireless identification functions, which dramatically increases hardware volume and does not aid hardware architecture integration. Note that, the RF antenna of the electronic tag requires significant room for electromagnetic coupling to guarantee good RF communication quality, and is especially disadvantageous when embedding the electronic tag within the portable electronic devices.

Therefore, implementing the RF antenna of the electronic tag in the portable devices more economically has been a major focus of the industry.

### SUMMARY OF THE INVENTION

It is therefore a primary objective of the claimed invention to provide an audio broadcasting device and portable device using the same.

An embodiment of the invention discloses an audio broadcasting device with a radio frequency identification function. The audio broadcasting device comprises a loudspeaker comprising a metal coil for generating sounds, an audio processing circuit for outputting an audio signal to the loudspeaker to drive the loudspeaker to generate the sounds, and an electronic tag module comprising a capacitor coupled to the metal coil in parallel, and a storage unit coupled to the capacitor in parallel for storing identification information, wherein the metal coil and the capacitor are utilized for generating an induced voltage potential according to a query signal broadcasted by a radio frequency identification reader, to drive the storage unit to feed the identification information back to the radio frequency identification reader.

An embodiment of the invention further discloses a portable device with both multimedia and radio frequency identification functions. The portable device comprises an operating circuit for implementing functions of the portable device, an audio broadcasting device comprising a loudspeaker comprising a metal coil for generating sounds, and an audio processing circuit for outputting an audio signal to the loudspeaker to drive the loudspeaker to generate the sounds, and an electronic tag module comprising a capacitor coupled to the metal coil in parallel, and a storage unit coupled to the capacitor in parallel for storing identification information, wherein the metal coil and the capacitor are utilized for generating an induced voltage potential according to a query signal broadcasted by a radio frequency identification reader, to drive the storage unit to feed the identification information back to the radio frequency identification reader.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an audio broadcasting device according to an embodiment of the invention.

FIG. 2 is a schematic diagram of a portable device according to an embodiment of the invention.

### DETAILED DESCRIPTION

Embodiments of the invention may implement a radio frequency (RF) antenna of an electronic tag by a metal coil of a loudspeaker, such that the electronic tag can be integrated into an ordinary circuit of a portable device.

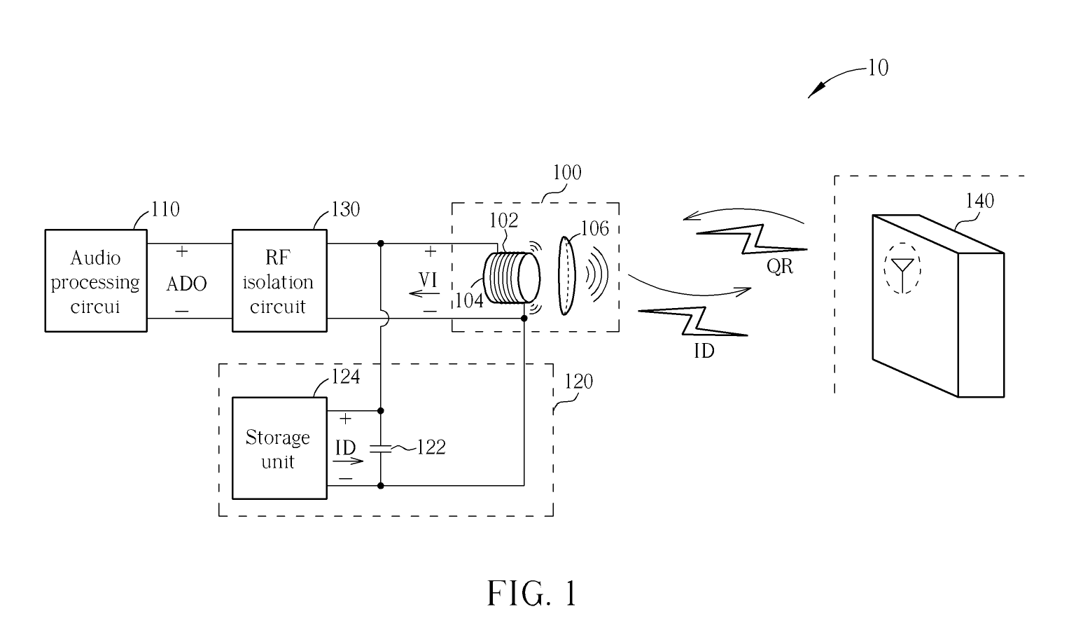

First, please refer to FIG. 1, which is a schematic diagram of an audio broadcasting device 10 according to an embodiment of the invention. Other than performing audio broadcasting, the audio broadcasting device 10 further has a RF identification function, and includes a loudspeaker 100, an audio processing circuit 110, an electronic tag module 120 and an RF isolation circuit 130. The loudspeaker 100 includes a metal coil 102 for generating sounds by resonance between a permanent magnet 104 and a membrane 106. The audio processing circuit 110 is utilized for outputting an audio signal ADO to the loudspeaker 100 to drive the loudspeaker 100 to generate sounds. The electronic tag module 120 includes a capacitor 122 and a storage unit 124. The storage unit 124 is utilized for storing identification information ID. The capacitor 122 and the metal coil 102 are utilized for generating an induced voltage potential VI in response to a query signal QR broadcasted by a wireless RF identification reader 140, to drive the storage unit 124 to feed the identification information ID back to the wireless RF identification reader 140. In addition, the RF isolation circuit 130 is utilized for preventing the induced voltage potential VI and the identification information ID from entering the audio processing circuit 110.

In short, the metal coil 102 of the audio broadcasting device 10 further functions as an antenna of a client of a wireless RF identification system to share a sound resonance space with the loudspeaker 100. That is, the sound resonance space further functions as an electromagnetic coupling space of the antenna to enhance antenna performance. By sharing the same output device (the metal coil 102), the audio broadcasting function and the wireless RF identification function of the audio broadcasting device 10 are integrated to reduce size and cost of the audio broadcasting device 10. As a result, sizes of applications of the audio broadcasting device 10, such as mobile phones, personal digital assistant (PDA), etc., can be reduced to meet the trend of “being as small as possible”.

To avoid undesired interaction between the audio broadcasting function and the wireless RF identification function, the RF isolation circuit 130 is preferably a bidirectional low-pass filter. As long as a cut-off frequency of the bidirectional low-pass filter is greater than a frequency band of the audio signal ADO and less than frequency bands of the induced voltage potential VI and the identification information ID, the induced voltage potential VI and the identification information ID cannot enter the audio processing circuit 110, which guarantees that the audio signal ADO is correctly outputted to the loudspeaker 100. Correspondingly, the audio processing circuit 110 has to stop outputting the audio signal ADO when the metal coil 102 receives the query signal QR or transmits the identification information ID to ensure the correctness of the wireless RF identification function.

Preferably, the loudspeaker 100 is an electromagnetic loudspeaker, which converts electric energy and magnetic energy into mechanical energy through electromagnetic induction, and then converts the mechanical energy into sound by resonance between the metal coil 102 and the membrane 106. Certainly, other than the electromagnetic loudspeaker, the loudspeaker 100 can be any speaker including a metal coil with corresponding sound resonance space. In such a situation, frequency response of the metal coil and the capacitor 122 may match the frequency band of the query signal QR by tuning capacitance of the capacitor 122, so as to receive and transmit RF signals precisely.

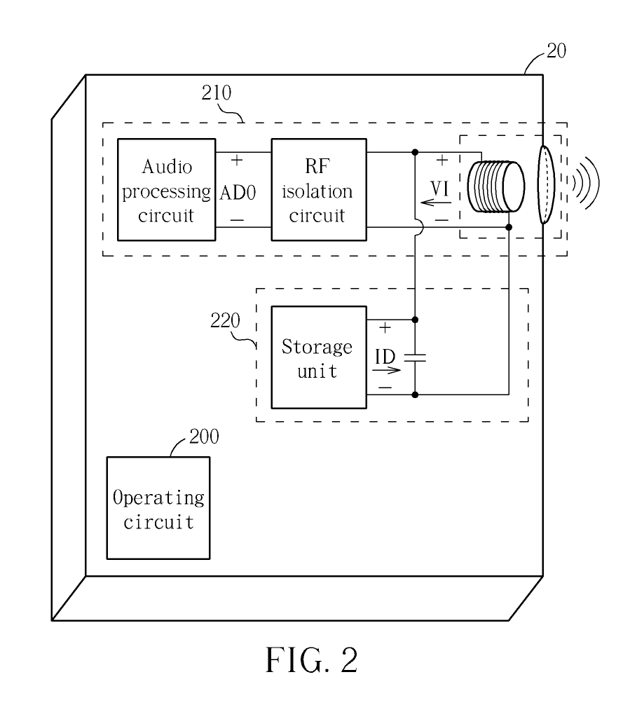

To embed the audio broadcasting device 10 in practical circuits, please refer to FIG. 2, which is a schematic diagram of a portable device 20 according to an embodiment of the invention. The portable device 20 has both multimedia and radio frequency identification functions, and includes an operating circuit 200, a loudspeaker 210 and an electronic tag module 220. The operating circuit 200 is utilized for implementing functions of the portable device 20. Combination of the audio broadcasting device 210 and the electronic tag module 220 is the audio broadcasting device 10 shown in FIG. 1, and is not further narrated herein. In general, the portable device 20 can be a computer system, a PDA or a mobile phone, etc.

Corresponding to the functional switch of the audio broadcasting device 10, the portable device 20 can temporarily disable functions related to audio broadcasting when sensing RF signals to guarantee correctness of the wireless RF identification function. For example, a smart phone with the wireless RF identification function may immediately stop broadcasting music or conversation contents when the smart phone exchanges RF signals with an RF reader, and may resume broadcasting when the RF communication ends.

In the prior art, the loudspeaker of the portable device and the output device of the wireless RF identification system are independent, and occupy exclusive hardware spaces. In such a situation, size of the portable device cannot be effectively reduced. In comparison, according to the invention, the metal coil 102 of the loudspeaker 100 further functions as the antenna of the client of the wireless RF identification system to save hardware space of the portable device 20. In addition, by preventing the RF signals from entering the audio processing circuit 110 and disabling the audio processing circuit 110, the audio broadcasting function and the wireless RF identification function can share the output device to reduce size and costs of the portable device 20.

To sum up, the invention transmits and receives RF signals via the metal coil of the loudspeaker to reduce hardware space of the portable device.

Those skilled in the art will readily observe that numerous modifications and alterations of the device and method may be made while retaining the teachings of the invention.

What is claimed is:

1. An audio broadcasting device with a radio frequency identification function, the audio broadcasting device comprising:
a loudspeaker, comprising a metal coil for generating sounds;
an audio processing circuit, for outputting an audio signal to the loudspeaker to drive the loudspeaker to generate the sounds; and
an electronic tag module, comprising:
a capacitor, coupled to the metal coil in parallel; and
a storage unit, coupled to the capacitor in parallel, for storing identification information;
wherein the metal coil and the capacitor are utilized for generating an induced voltage potential according to a query signal broadcasted by a wireless radio frequency identification reader, to drive the storage unit to feed the identification information back to the wireless radio frequency identification reader.

2. The audio broadcasting device of claim 1 further comprising a radio frequency isolation circuit, coupled between the audio processing circuit and the loudspeaker, for preventing the induced voltage potential and the identification information from entering the audio processing circuit.

3. The audio broadcasting device of claim 2, wherein the radio frequency isolation circuit is a bidirectional lowpass filter with a cut-off frequency greater than a frequency band of the audio signal and less than frequency bands of the induced voltage potential and the identification information.

4. The audio broadcasting device of claim 1, wherein the audio processing circuit stops outputting the audio signal when the metal coil receives the query signal or transmits the identification information.

5. The audio broadcasting device of claim 1, wherein the loudspeaker is an electromagnetic loudspeaker.

6. A portable device with both multimedia and radio frequency identification functions, the portable device comprising:
an operating circuit, for implementing functions of the portable device;
an audio broadcasting device, comprising:
a loudspeaker, comprising a metal coil for generating sounds; and
an audio processing circuit, for outputting an audio signal to the loudspeaker to drive the loudspeaker to generate the sounds; and
an electronic tag module, comprising:
a capacitor, coupled to the metal coil in parallel; and
a storage unit, coupled to the capacitor in parallel, for storing identification information;
wherein the metal coil and the capacitor are utilized for generating an induced voltage potential according to a query signal broadcasted by a wireless radio frequency identification reader, to drive the storage unit to feed the identification information back to the wireless radio frequency identification reader.

7. The portable device of claim 6 further comprising a radio frequency isolation circuit, coupled between the audio processing circuit and the loudspeaker, for preventing the induced voltage potential and the identification information from entering the audio processing circuit.

8. The portable device of claim 7, wherein the radio frequency isolation circuit is a bidirectional lowpass filter with a cut-off frequency greater than a frequency band of the audio signal and less than frequency bands of the induced voltage potential and the identification information.

9. The portable device of claim 6, wherein the audio processing circuit stops outputting the audio signal when the metal coil receives the query signal or transmits the identification information.

10. The portable device of claim 6, wherein the loudspeaker is an electromagnetic loudspeaker.
